(19) United States
(12) Patent Application Publication
(10) Pub. No.: US 2019/0059471 A1
(43) Pub. Date: Feb. 28, 2019

(54) Splash Resistant Facemask

(71) Applicant: O&M Halyard, Inc., Mechanicsville, VA (US)

(72) Inventors: Roger B. Quincy, III, Cumming, GA (US); Bryan James Stadelman, Alpharetta, GA (US); Elaine M. Namba, Decatur, GA (US); Catherine J. Turnbow, Cumming, GA (US)

(21) Appl. No.: 16/175,931

(22) Filed: Oct. 31, 2018

Related U.S. Application Data
(63) Continuation of application No. 13/100,353, filed on May 4, 2011, now abandoned.
(60) Provisional application No. 61/425,875, filed on Dec. 22, 2010.

(51) Int. Cl. A41D 13/11

(52) U.S. Cl. CPC A41D 13/11; A62B 23/025

(57) ABSTRACT

There is provided a splash resistant facemask having two outer splash layers adjacent each other on a side away from a wearer, a filter layer and an inside layer. None of the layers contains a repellent treatment. The facemask can pass a fluid splash resistance test, e.g. ASTM F-1862-05, wherein fluid is directed at the mask at a pressure of 160 mmHg.

### RELATED APPLICATIONS

This application claims the benefit of priority from U.S. Provisional Application No. 61/425,875 filed on Dec. 22, 2010, the contents of which are incorporated herein by reference in its entirety. In addition, this application is a continuation of U.S. application Ser. No. 13/100,353 filed on May 4, 2011, the contents of which are incorporated herein by reference in its entirety.

### BACKGROUND

The present disclosure generally relates to face masks. In particular the disclosure relates to an assembly of material layers that provides splash resistance used in constructing the body portion of face masks (used to cover the mouth, nasal openings, and most of the cheeks).

Medical professionals involved in caring for sick and injured patients can be exposed to bodily fluids that may carry disease and transmit it to the medical professional through contact with the skin and mucous membranes. Those diseases of most concern include hepatitis and AIDS but also include avian flu, SARS, west Nile disease and others. While medical professionals must of course exercise care in dealing with infected individuals, protective attire like gowns, gloves and facemasks are used to minimize contact with the vectors of infection. It is particularly important that the mucus membranes of the mouth be protected from inadvertent splashes of blood and other bodily fluids.

The challenge in providing splash resistance to face masks is to maintain an acceptable level of breathability while prohibiting splashes as well as minute airborne (virus) particles from passing through the mask and being inhaled by the wearer. Since masks cover the mouth and nasal openings, the heat and moisture from expired air creates micro-climates between the exterior of the mask and the covered skin; such micro-climates are often perceived as uncomfortable for the person wearing the mask. One measure of air flow through a material layer or layers follows the procedure steps described in ASTM D737-04. This gives quantifiable air permeability values for the layer or layers at a water pressure differential of 125 Pascals. The procedure steps of ASTM D737 used in determining air permeability values are described in U.S. Pat. No. 4,748,065.

Ways to impart splash resistance involve merely adding more layers to the mask, increasing the thickness of existing layers in the mask, or reducing the size or number of open pores of one or more of these layers. All of these approaches tend to compromise the flow of air, heat, and moisture of expired air through the mask. Another way to impart splash resistance is to alter the surface energy attributes of the material layers which can be done with chemical treatments. There are a variety of repellent finishes used on fabrics including fiber reactive hydrocarbon hydrophobes, silicone water repellents and fluorochemical repellents.

Fluorochemical repellents are unique in that they confer both water and low surface tension fluids repellent to fabrics. This property is important because blood and alcohol, common liquids in an operating room, are low surface tension liquids. The ability of fluorochemicals to repel low surface tension liquids is related to their low surface energy. The fluorochemical finishes are organic fluorine-containing compounds in which a majority of the hydrogen atoms are replaced by fluorine. When these compounds are applied to fabric followed by drying and curing, the fluorochemical tails orient themselves away from the fibers to produce a very low surface energy barrier.

While fluorocarbon treatments may increase the repellency of facemasks, there is concern regarding the safety of such treated materials. Many uses of fluorocarbons were phased out in the United States in the 1970s and 1980 due to concerns of safety and environmental degradation.

The challenge of providing a fluorocarbon free mask that will provide sufficient splash resistance to be used in a surgical setting remains. This is an area of great importance to those in the medical profession and represents an important area of research for those concerned about the safety of not only medical professionals but of their patients as well.

There thus remains a need for a facemask that can protect a medical worker from exposure to the blood and bodily fluids of a patient and which does not contain a repellent treatment. The desired facemask should be sufficiently breathable yet resist penetration by splashes of blood.

### SUMMARY

The fluid resistant face mask is desirably a construction having two outer splash layers adjacent each other on the side away from the wearer, a filter layer and an inside layer. None of the material components of the mask contain a repellent treatment.

It is desirable that the splash layers have a combined basis weight of at least 1.4 osy (47.5 gsm) where the second (inner) splash layer has at least a 0.8 osy (27 gsm) basis weight and an air permeability value of greater than 250 CFM/Ft2. The splash layers also desirably have a stiffness of at least 3.5 according to ASTM standard test D-1388, with slight modifications.

The mask can withstand a splash resistance test in which a fluid like synthetic blood is directed at the mask at a pressure of 160 mmHg according to, for example, ASTM F-1862-05.

The filter layer desirably has an air permeability value greater than 40 CFM/Ft2.

The overall mask desirably has an air permeability of at least 30 CFM/Ft2.

### BRIEF DESCRIPTION OF THE DRAWINGS

FIG. 1 is a drawing of the layout of the test equipment used in the ASTM F1862-05; the Standard Method for Resistance of Medical Facemasks to Penetration by Synthetic Blood (Horizontal Projection of Fixed Volume at a Known Velocity).

FIG. 2 is a depiction of the layers of the disclosed face mask showing two outer splash layers, a filter layer and a layer suitable for comfortable contact with the skin.

### DETAILED DESCRIPTION

Fluid splash resistance for face masks is measured according to ASTM method F1862-05. A certain level of splash resistance, designated “Level 3”, is achieved when a mask or a construction of assembled layers of materials (that will form the mask body) can keep 2.0 grams of a synthetic blood fluid from penetrating the inside layer when the fluid is squirted at a pressure of 160 mmHg to strike the outermost layer. A “Level 3 pass” rating for splash resistance is given for the mask- or construction-type when at least 29 out of 32 specimens of a sampling show no penetration of fluid through their inside layer at the Level 3 conditions. Likewise a “level 2” mask has resistance to fluid penetration measured in the same manner but at a pressure of 120 mmHg.

In addition to fluid resistance, in order for the mask generally to be designated level 2 or level 3, certain other criteria must also be satisfied. These include resistance to flammability, pressure differential (delta P), particle filtration efficiency, and bacterial filtration efficiency. This disclosure is concerned with masks that satisfy the level designation for at least the splash resistance.

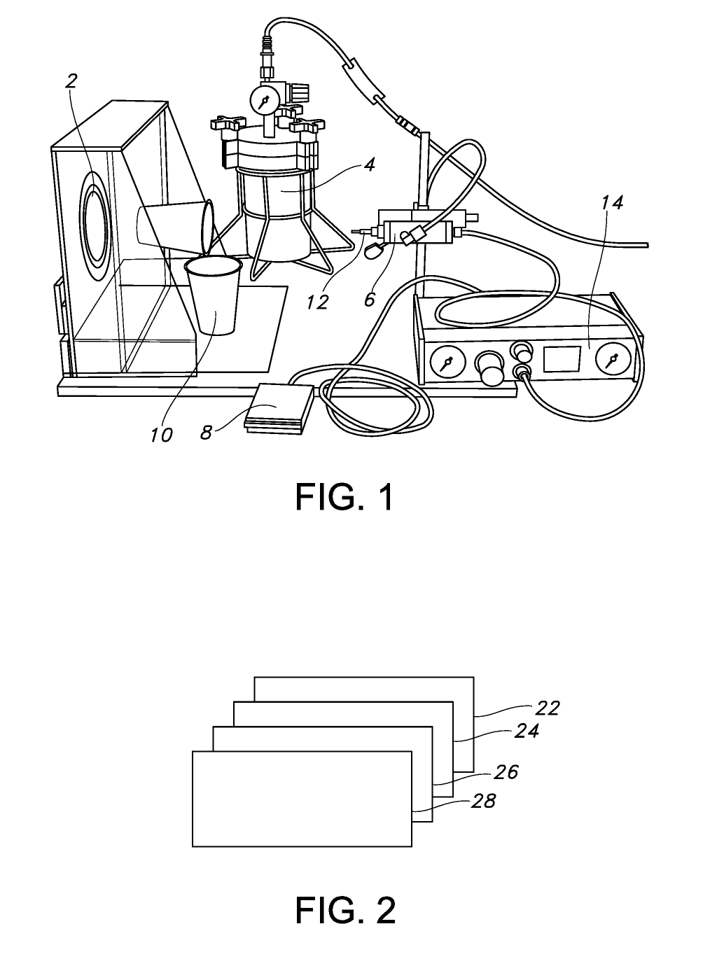

One can also determine directional changes in splash resistance by tracking the number (and therefore percentage) of specimens of a sampling that show no such fluid penetration. This provides information about splash resistance when one has fewer than 32 specimens in a sampling. Such tracking was recorded for sample sets of the subsequent Tables (Tables 2-5) and reported in the right-most column of these Tables as the number of specimens that passed the level 3 splash criteria with respect to the total specimens tested—these numbers are those inside the parentheses, e.g. for Table 2A: (20/32), meaning 20 specimens passed out of the 32 specimens tested). The equipment used for this method is shown in FIG. 1.

As described in ASTM F1862-05 and depicted in FIG. 1, a sample is placed in the sample holder 2. Liquid is directed toward the sample horizontally (at a 90° angle to the sample) from a pressurized fluid reservoir 4 via a valve 6 that is controlled by a valve switch 8. The sample holder 2 has a targeting plate and collection cups 10 to channel and collect excess fluid. The fluid is delivered from the valve 6, through a cannula 12 and impinges on the sample. A valve timing controller 14 may also be used to control the valve opening and duration of the test.

To overcome the shortcomings of previous mask constructions, material components and face mask design have been leveraged to provide masks with: (1) high levels of fluid splash resistance, (2) the ability to absorb more of the fluid splash, (3) low fluid interaction with the filter layer, and (4) acceptable comfort as measured by air permeability via ASTM D737-04 procedures.

The splash resistant face mask disclosed here (see also FIG. 2) has, in general terms, a first splash resistant layer 28, a second splash layer 26 between the first splash layer and the filter layer 24, and an inner comfort layer 22 for contact with the skin of a wearer.

The filtration layer 24 is most commonly a layer made by the meltblowing process as described below. The meltblown filter layer 24 is lightweight, generally between 0.3 and 0.9 osy (10.2 and 30.5 gsm) and usually made from a polyolefin like polypropylene due to cost considerations, though other polymers would function as well.

The splash layers 28, 26 may be a number of different materials including spunbond fabrics, polyester cellulose wetlaid fabrics and apertured films. These materials should have very high air permeability rates (e.g. greater than 200 cfm/ft2). These layers must also not be too flexible but have sufficient stiffness to maintain their shape and integrity when impinged upon by a liquid stream (e.g. a splash).

The innermost layer should be comfortable when in contact with the skin and also possessing a high breathability rating. Suitable materials include polyester cellulose wetlaid materials and other nonwoven materials like spunbond and meltblown layers and combinations thereof, again having air permeability rated of greater than 200 cfm/ft2, more desirably greater than 300 cfm/ft2.

More particularly, the splash resistant face mask is desirably a construction involving the following:
at least 4 separate layers that collectively pass ASTM method F1862-05
none of the material components of the mask design contains a repellent treatment.
at least 2 adjacent splash layers, a first splash layer and a second splash layer, and these layers are positioned in the assembly so that the second splash layer is adjacent the filter layer.
both adjacent splash layers are recognized as needing a certain stiffness, e.g. drape stiffness, to contribute to the level 3 splash resistance. This level is met for the 0.7 and 0.9 osy (27.1 and 30.5 gsm) spunbond (SB), the 0.5 osy (17 gsm) Poly-Cell (polyester cellulose) wetlaid, but not for the 0.53 osy (17 gsm) SB & meltblown (MB) (test results below).
the second splash layer desirably has at least a 0.8 osy basis weight and an air permeability value of greater than about 250 CFM/Ft²
a filter layer with an air permeability value greater than 40 CFM/Ft² desirably greater than 45 and still more desirably greater than 50. The filter is desirably a meltblown fabric layer having a basis weight between 0.4 and 0.9 osy, more desirably about 0.6 osy.
an inner layer that provides for skin comfort, having a basis weight between 0.3 and 0.9 osy, desirably about 0.5 osy.
an overall face mask air permeability of at least 30 CFM/Ft² desirably greater than 35 and still more desirably greater than 40.

One assembly of the separate layers that conform to the disclosed mask is shown in FIG. 2.

Details of representative layers used for the disclosed masks and comparative masks and their respective air permeability values are listed in Table 1. Note that spunbond and meltblown fabrics are polypropylene unless otherwise noted.

TABLE 1

| Materials | | | Air | | |
|---|---|---|---|---|---|
| for | | | Permeability | | |
| layers: | Identifying Description | Basis wt., osy | (AP) Avg | Std Dev | Reps |
| VISPORE ® | Microfunnel Film, MED-40 HEX, | 0.86 | 285 | 32 | 16 |
| Film | 10/1/07, FG# F110176 | | | | |
| SB | Spunbond by PGI; Orange) | 0.9 | 402 | 26 | 15 |
| SB | Spunbond by PGI; Orange (Higher | 0.9 | 453 | 15 | 5 |
| | Pigment Level) | | | | |
| SB | Spunbond by PGI; Orange (Higher | 1.4 | 262 | 14 | 5 |
| | Pigment Level) | | | | |
| SB | Spunbond by Kimberly-Clark; Orange | 0.9 | 403 | 17 | 15 |
| SB | Spunbond by PGI; white | 0.7 | 514 | 23 | 10 |
| Poly-Cell | wetlaid nonwoven by AHLSTROM; | 0.5 | 280 | 7 | 12 |
| | 55% polyester staple & 45% rayon | | | | |
| | staple, White | | | | |
| Poly-Cell | wetlaid nonwoven by AHLSTROM; | 0.5 | 270 | 4 | 11 |
| | 55% polyester staple & 45% rayon | | | | |
| | staple, Orange | | | | |
| SB&MB | Proprietary structure of polyolefin | 0.53 | 458 | 18 | 4 |
| | meltspun fibers consisting of | | | | |
| | polypropylene and more flexible | | | | |
| | polyethylene | | | | |
| MB | Meltblown by Kimberly-Clark | 0.6 | 63 | 2 | 4 |
| MB | Meltblown by Kimberly-Clark | 0.6 | 115 | 4 | 12 |
| MB | Meltblown by Kimberly-Clark | 0.6 | 76 | 2 | 11 |
| MB | Meltblown by Kimberly-Clark | 0.45 | 87 | 4 | 7 |
| Kraton | Elastomeric Meltblown from | 1.4 | 280 | 20 | 3 |
| MB | Kraton's MD6717 polymer | | | | |

The importance of having multiple layers in front of (i.e. on the side away from the wearer) the meltblown filtration layer to achieve level 3 splash resistance can be seen by comparing the fluid splash resistance data shown in Table 2 A and B. These mask designs were tested in the form of layered sheets of various materials and not in finished face mask form. It can be seen that placement of a Vispore® film material (apertured film described in U.S. Pat. No. 4,920,960) in front of the meltblown layer to give two layers in front of the meltblown allows the mask prototype to achieve level 3 fluid resistance (31 of 32 samples pass). Placing the splash layers on either side of the meltblown filter layer (Table 2A) did not yield a sufficiently splash resistant result. Apertured films (e.g. Vispore® film) have a particular characteristic structure that has been associated with the free passage of gases through the layer in either direction, while restricting passage of liquids in at least one direction.

TABLE 2A

| | Splash 1 | | | MB | | | | | | | | Mask Air | |
|---|---|---|---|---|---|---|---|---|---|---|---|---|---|
| | (Outer Layer) | | | FILTER LAYER | | Splash 2 | | | Inner Layer | | | Perm | |
| Sample | Mat'l | osy | AP | osy | AP | Mat'l | osy | AP | Mat'l | osy | AP | AP | Level 3 |
| 1 | Poly- | 0.5 | 270 | 0.6 | 76 | Vispore ® | 0.86 | 285 | Poly- | 0.5 | 280 | 50.4 ± 1.9 | Fail |
| | Cell | | | | | Film | | | Cell | | | | (20/32) |

TABLE 2B

| | SPLASH LAYERS | | | | | | | | | | | | |
|---|---|---|---|---|---|---|---|---|---|---|---|---|---|
| | Splash 1 | | | | | | MB | | | | | Mask Air | |
| | (Outer Layer) | | | Splash 2 | | | FILTER LAYER | | Inner Layer | | | Perm | |
| Sample | Mat'l | osy | AP | Mat'l | osy | AP | osy | AP | Mat'l | osy | AP | AP | Level 3 |
| 2 | Poly- | 0.5 | 270 | Vispore ® | 0.86 | 285 | 0.6 | 76 | Poly- | 0.5 | 280 | 51.7 ± 1.8 | Pass |
| | Cell | | | Film | | | | | Cell | | | | (31/32) |

The examples in Table 3 illustrate the importance of material selection in a 4-layer mask design for passing level 3 splash resistance. When the outer layer, the first splash layer, was a low basis weight material (e.g. 0.5 osy orange striped Poly-Cell) the selection of the second splash layer becomes more important. Note that the first three constructions use a relatively high air perm MB (AP=76) filter layer. This 4-layer design was tested in layered sheet form, not in finished mask form. Also note that for sample 15, the SB&MB splash layer is believed to be too flexible (not sufficiently stiff) to manage the liquid impact; it allows too much liquid through to the second splash layer and subsequent layers. The flexibility of this SB&MB splash layer was measured with the drape stiffness test, also called the cantilever bending test. This procedure follows ASTM standard test D-1388 except for the fabric length which is different (1 inch by 8 inches or 2.5 cm by 20.3 cm). By comparison, the Poly-cell Splash 1 (Outer Layer) in Sample 6 was also measured. Drape stiffness test results are shown in Table 6. The fabrics of the splash layers for use in the disclosed facemask desirably have a drape stiffness of at least 3.5, more desirably more than 4.0 and still more desirably more than 4.5.

TABLE 3

| | SPLASH LAYERS | | | | | | | | | | | | |
|---|---|---|---|---|---|---|---|---|---|---|---|---|---|
| | Splash 1 | | | | | | MB FILTER | | | | | Mask Air | |
| | (Outer Layer) | | | Splash 2 | | | LAYER | | Inner Layer | | | Perm | |
| Sample | Mat'l | osy | AP | Mat'l | osy | AP | osy | AP | Mat'l | osy | AP | AP | Level 3 |
| 3 | Poly- | 0.5 | 270 | SB | 0.9 | 453 | 0.6 | 76 | Poly- | 0.5 | 280 | 51.8 ± 1.4 | Fail |
| | Cell | | | | | | | | Cell | | | | (17/32) |
| 4 | Poly- | 0.5 | 270 | MD6717 | 1.4 | 280 | 0.6 | 76 | Poly- | 0.5 | 280 | 47.5 ± 0.7 | Fail |
| | Cell | | | | | | | | Cell | | | | (5/32) |
| | | | | (Kraton | | | | | | | | | |
| | | | | MB) | | | | | | | | | |
| 5 | Poly- | 0.5 | 270 | SB | 1.4 | 262 | 0.6 | 76 | Poly- | 0.5 | 280 | 48.0 ± 0.7 | Pass |
| | Cell | | | | | | | | Cell | | | | (31/32) |
| 6 | Poly- | 0.5 | 280 | SB | 0.9 | 402 | 0.6 | 63 | Poly- | 0.5 | 280 | 42.0 ± 1.4 | Pass |
| | Cell | | | | | | | | Cell | | | | (32/32) |
| 15 | SB&MB | 0.53 | 458 | SB | 0.9 | 402 | 0.45 | 87 | Poly- | 0.5 | 280 | 60.2 ± 1.6 | Fail |
| | | | | | | | | | Cell | | | | (4/10) |

The Sample 15 splash 1 outer layer is from Avgol America Inc., 178 Avgol Drive, Mocksville, N.C., 27028. It was labeled YD-018-26 and described as a polyethylene sheath/polypropylene core bicomponent spunbond SMS fabric. The meltblown portion is polypropylene. It should be noted that polyolefins are normally hydrophobic without a repellent treatment. This fabric was believed to be insufficiently stiff for use in the splash layers of the face mask disclosed herein, i.e., it had a drape stiffness below 3.5 and so failed the test (see Table 6).

The examples of Table 4 show 4-layer designs that passed level 3 using the same splash layers, two different inner layer materials, and four different MB filter layers. Sample 12 passed the level 3 splash test using two 0.9 osy SB splash layers, a 0.6 osy meltblown filter layer and a 0.5 osy polyester cellulose inner layer. Sample 11 was nearly identical to sample 12 with a lower basis weight meltblown filter layer, and failed the splash test, indicating that for this combination of layers a heavier meltblown filter layer was necessary. Sample 10 was nearly identical to sample 11 with an inner layer made from the Avgol YD-018-26 used in the splash layer of sample 15 (described above) and passed the splash test. This result shows that while this sample 10 was quite similar to sample 11, the naturally hydrophobic SB&MB inner layer of sample 10 allowed this sample 10 to pass the splash test while the poly-cell inner layer of sample 11 did not. In addition, the low drape stiffness of the Avgol SB&MB material was not as critical to splash performance when it was the inner layer when compared to when it was the outer layer in sample 15.

Note that the first two samples in Table 4 were tested in finished mask form. The last four samples were tested in layered sheet form. Note that a very high air permeability 0.6 osy (20.3 gsm) meltblown of 115 cfm/ft² was included for this study set.

TABLE 4

| | SPLASH LAYERS | | | | | | | | | | | | |
|---|---|---|---|---|---|---|---|---|---|---|---|---|---|
| | Splash 1 (Outer | | | | | | MB FILTER | | | | | Mask Air | |
| | Layer) | | | Splash 2 | | | LAYER | | Inner Layer | | | Perm | |
| Sample | Mat'l | osy | AP | Mat'l | osy | AP | osy | AP | Mat'l | osy | AP | AP | Level 3 |
| 7 | SB | 0.9 | 402 | SB | 0.9 | 402 | 0.6 | 76 | Poly- | 0.5 | 280 | *47.5 ± 0.8 | Pass |
| | | | | | | | | | Cell | | | | (30/32) |
| 8 | SB | 0.9 | 402 | SB | 0.9 | 402 | 0.6 | 76 | SB&MB | 0.53 | 458 | *48.8 ± 1.8 | Pass |
| | | | | | | | | | | | | | (32/32) |
| 9 | SB | 0.9 | 402 | SB | 0.9 | 402 | 0.6 | 115 | Poly- | 0.5 | 280 | 60 | Pass |
| | | | | | | | | | Cell | | | | (29/32) |
| 10 | SB | 0.9 | 402 | SB | 0.9 | 402 | 0.45 | 87 | SB&MB | 0.53 | 458 | 61.9 ± 3.4 | Pass |
| | | | | | | | | | | | | | (32/32) |
| 11 | SB | 0.9 | 402 | SB | 0.9 | 402 | 0.45 | 87 | Poly- | 0.5 | 280 | 62.4 ± 1.0 | Fail |
| | | | | | | | | | Cell | | | | (25/32) |
| 12 | SB | 0.9 | 402 | SB | 0.9 | 402 | 0.6 | 63 | Poly- | 0.5 | 280 | 43.1 ± 1.8 | Pass |
| | | | | | | | | | Cell | | | | (32/32) |

*denotes AP measurements for layers fabricated into a mask via commercial equipment

The examples in Table 5 show two 5-layer constructions (4 layers plus an additional splash layer) that did not pass level 3. Of note is comparing results for Sample 14 to the Table 4 Samples that have 2 identical SB splash layers of 0.9 osy. Surprisingly, even the heavier sample 14, with three splash layers with a combined basis weight of 2.0 osy (68 gsm) failed the splash test while the two layer splash layer with a basis weight of 1.8 osy (61 gsm), sample 9, passed the test.

TABLE 5

| | SPLASH LAYERS | | | | | | | | | | | | | | | |
|---|---|---|---|---|---|---|---|---|---|---|---|---|---|---|---|---|
| | Splash 1 | | | | | | | | | MB | | | | | Mask | |
| | (Outer | | | | | | | | | FILTER | | | | | Air | |
| | Layer) | | | Splash 2 | | | Splash 3 | | | LAYER | | Inner Layer | | | Perm | |
| Sample | Mat'l | Osy | AP | Mat'l | osy | AP | Mat'l | Osy | AP | osy | AP | Mat'l | osy | AP | AP | Level 3 |
| 13 | SB | 0.7 | 514 | SB | 0.7 | 514 | SB | 0.7 | 514 | 0.6 | 115 | Poly- | 0.5 | 280 | 59 ± 2 | Fail |
| | | | | | | | | | | | | Cell | | | | (25/32) |
| 14 | SB | 0.9 | 402 | SB | 0.55 | | SB | 0.55 | | 0.6 | 115 | Poly- | 0.5 | 280 | 60 | Fail |
| | | | | | | | | | | | | Cell | | | | (24/32) |

TABLE 6
Drape Stiffness Data (ASTMD-1388 with 1″ by 8″ pieces)

| | Sample 6 | Sample 15 | Sample 12 |
|---|---|---|---|
| | splash 1 | splash 1 | splash 1 |
| | 4.25 | 3.15 | 4.15 |
| | 4.70 | 3.00 | 3.60 |
| | 4.75 | 3.15 | 3.95 |
| | 4.65 | 2.70 | 3.85 |
| | 4.55 | 3.40 | 4.05 |
| Average: | 4.58 | 3.08 | 3.920 |
| Standard | 0.20 | 0.26 | 0.211 |
| deviation: | | | |

Table 7 contains data from still more air permeability testing for a level 3 splash resistant mask. In this case the materials are two layers of 0.9 spunbond splash layers, a 0.6 osy meltblown filter layer and a 0.5 osy poly-cell wetlaid inner facing. The overall mask air permeability is given also. All results are in cfm/ft².

In the tables, PGI refers to Polymer Group Inc. of Charlotte, N.C. PGI is a leading global engineered materials company, focused primarily on the production of nonwovens for the hygiene, wipes, medical, and industrial markets. PGI's internet site is at http://www.polymergroupinc.com/en/. Ahlstrom is a global developer and manufacturer of high performance specialty papers and fiber composites for industrial applications. Ahlstrom's internet site is at http://www.ahlstrom.com/en/aboutAhlstrom/Pages/default.aspx.

The disclosed masks have also been observed to retain or absorb more of the splash in Level 3 splash resistance testing compared to other masks that are similar yet with different constructions. For example, masks with a repellent treated (e.g. fluorochemical) outer layer were found to ricochet (or bounce off) the splashed fluid instead of absorbing and/or trapping it within the mask. The sterile surgical site can be compromised with fluid that is ricocheted from a mask. “Repellent treatment” refers to a chemical treatment that improves repellency to low surface tension fluids. For example, PP fabrics are treated with fluorochemicals to improve repellency to isopropyl alcohol (IPA). Without the fluorochemical treatment, the isopropyl alcohol repellency of PP fabrics is only 20% IPA/water. The fluorochemical treatment is designed to improve the repellency of PP to at least 70% IPA/water. A repellent treatment as the term is used herein would be any treatment that provides the fabric (PP, wetlaid, etc.) with repellency to at least 30% IPA/water.

As used herein the term “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (from a sample of at least 10) larger than 7 microns, more particularly, between about 10 and 20 microns. The fibers may also have shapes such as those described in U.S. Pat. No. 5,277,976 to Hogle et al., U.S. Pat. No. 5,466,410 to Hills and U.S. Pat. Nos. 5,069,970 and 5,057,368 to Largman et al., which describe fibers with unconventional shapes.

As used herein the term “bicomponent fibers” refers to fibers which have been formed from at least two polymers extruded from separate extruders but spun together to form one fiber. Bicomponent fibers are also sometimes referred to as multicomponent or conjugate fibers. The polymers are usually different from each other though bicomponent fibers may be made from a single type of polymer. The polymers are arranged in substantially constantly positioned distinct zones across the cross-section of the bicomponent fibers and extend continuously along the length of the bicomponent fibers. The configuration of such a bicomponent fiber may be, for example, a sheath/core arrangement wherein one polymer is surrounded by another or may be a side by side arrangement, a pie arrangement or an “islands-in-the-sea” arrangement. Bicomponent fibers are taught in U.S. Pat. No. 5,108,820 to Kaneko et al., U.S. Pat. No. 4,795,668 to Krueger et al., U.S. Pat. No. 5,540,992 to Marcher et al. and U.S. Pat. No. 5,336,552 to Strack et al. Bicomponent fibers are also taught in U.S. Pat. No. 5,382,400 to Pike et al. and may be used to produce crimp in the fibers by using the differential rates of expansion and contraction of the two (or more) polymers. For two component fibers, the polymers may be present in ratios of 75/25, 50/50, 25/75 or any other desired ratios. The fibers may also have shapes such as those described in U.S. Pat. No. 5,277,976 to Hogle et al., U.S. Pat. No. 5,466,410 to Hills and U.S. Pat. Nos. 5,069,970 and 5,057,368 to Largman et al., which describe fibers with unconventional shapes.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are generally tacky when deposited onto a collecting surface.

As used herein “multilayer nonwoven laminate” means a laminate wherein some of the layers are spunbond and some meltblown such as a spunbond/meltblown/spunbond (SMS) laminate and others as disclosed in U.S. Pat. No. 4,041,203 to Brock et al., U.S. Pat. No. 5,169,706 to Collier, et al, U.S. Pat. No. 5,145,727 to Potts et al., U.S. Pat. No. 5,178,931 to Perkins et al. and U.S. Pat. No. 5,188,885 to Timmons et al. Such a laminate may be made by sequentially depositing onto a moving forming belt first a spunbond fabric layer, then a meltblown fabric layer and last another spunbond layer and then bonding the laminate in a manner described below. Alternatively, the fabric layers may be made individually, collected in rolls, and combined in a separate bonding step. Such fabrics usually have a basis weight of from about 0.1 to 12 osy (6 to 400 gsm), or more particularly from about 0.75 to about 3 osy (101.7 gsm). Multilayer laminates may also have various numbers of meltblown layers or multiple spunbond layers in many different configurations and may include other materials like films (F) or coform materials, e.g. SMMS, SM, SFS, etc.

The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

The drape stiffness test, also sometimes called the cantilever bending test, determines the bending length of a fabric using the principle of cantilever bending of the fabric under its own weight. The bending length is a measure of the interaction between fabric weight and fabric stiffness. One version of this test uses a 1 inch (2.54 cm) by 8 inch (20.3 cm) fabric strip, sliding the strip at 4.75 inches per minute (12 cm/min) in a direction parallel to its long dimension so that its leading edge projects from the edge of a horizontal surface. The length of the overhang is measured when the tip of the specimen is depressed under its own weight to the point where the line joining the tip of the fabric to the edge of the platform makes a 41.5 degree angle with the horizontal. The longer the overhang the slower the specimen was to bend, indicating a stiffer fabric. The drape stiffness is calculated as 0.5× bending length. When more than one specimen of a sample is measured, the drape stiffness value is reported as an average of the individual specimens of the sample. This procedure follows ASTM standard test D-1388 except for the fabric length which is different (longer). The test equipment used is a Cantilever Bending tester model 79-10 available from Testing Machines Inc., 400 Bayview Ave., Amityville, N.Y. 11701. As in most testing, the sample should be conditioned to ASTM conditions of 65±2 percent relative humidity and 72±2° F. (22±1° C.), or TAPPI conditions of 50±2 percent relative humidity and 72±1.8° F. prior to testing.

As will be appreciated by those skilled in the art, changes and variations to the invention are considered to be within the ability of those skilled in the art. Such changes and variations are intended by the inventors to be within the scope of the invention. It is also to be understood that the scope of the present invention is not to be interpreted as limited to the specific embodiments disclosed herein, but only in accordance with the appended claims when read in light of the foregoing disclosure.

What is claimed is:

1. A method of manufacturing a fluid resistant facemask, the method comprising:
providing a first spunbond splash layer configured for a side away from a wearer's face;
securing a second splash layer made from a spunbond fabric or apertured film to an inner surface of the first spunbond splash layer;
arranging a meltblown filtration layer adjacent to the first and second splash layers; and
arranging an inner layer with the first and second splash layers and the meltblown layer to be worn against a wearer's face, wherein the first and second splash layers, the meltblown filtration layer, and the inner layer are absent of a repellent treatment, and
wherein the facemask passes an ASTM F-1862-05 level 3 test of splash resistance conducted at a pressure of 160 mmHg.

2. The method of claim 1, wherein the first and second splash layers have a combined basis weight of at least 1.4 osy and where the second splash layer has an air permeability value of greater than 250 CFM/Ft2.

3. The method of claim 1, wherein the meltblown filtration layer has an air permeability value greater than 40 CFM/Ft2.

4. The method of claim 1, wherein the facemask has an air permeability of at least 30 CFM/Ft².

5. The method of claim 1, wherein the first spunbond splash layer has a drape stiffness above 3.5.

6. The method of claim 5, wherein the first spunbond splash layer has a drape stiffness above 4.0.

7. The method of claim 6, wherein the first spunbond splash layer has a drape stiffness above 4.5.

8. The method of claim 1, wherein the second splash layer is comprised of an aperture film.

9. The method of claim 1, wherein the second splash layer has a basis weight of at least 0.8 osy.
